(19) United States
(12) Patent Application Publication
(10) Pub. No.: US 2023/0341825 A1
(43) Pub. Date: Oct. 26, 2023

(54) DYNAMICALLY OPTIMIZED ENVIRONMENTAL CONTROL SYSTEM (ECS)

(71) Applicant: Funai Electric Co., Ltd., Daito-shi, Osaka-fu (JP)

(72) Inventors: Vlad Grigore DABIJA, Mountain View, CA (US); Yanjun MA, Bellevue (CA); David Walter ASH, Kirkland, WA (US); Phillip SORRELLS, Highland Village, TX (US)

(73) Assignee: Funai Electric Co., Ltd., Daito-shi, Osaka-fu (JP)

(21) Appl. No.: 17/908,868

(22) PCT Filed: Nov. 9, 2020
(86) PCT No.: PCT/US2020/059710

§ 371 Date: Sep. 1, 2022

(51) Int. Cl. G05B 13/04

(52) U.S. Cl. CPC G05B 13/04

(57) ABSTRACT

Technologies are generally described for dynamic optimization of environmental controls. A system according to some examples may determine a person's environmental preferences and generate a time-based environmental control model for that person. The system may also generate a location model defining current and predicted future locations for the person. The environmental model may take into account person's previous or current activity and be adjusted based on sensed data from interior and exterior environmental sensors and body sensors on the person. Models for multiple people may be combined based on priorities or personal characteristics. Models may also be stored in mobile devices such that settings can be implemented in future locations prior to arrival of the person. Implemented settings may be adjusted for additional people as they arrive at the location.

### BACKGROUND

Unless otherwise indicated herein, the materials described in this section are not prior art to the claims in this application and are not admitted to be prior art by inclusion in this section.

Humans (as well as animals and plants) react to their environment. Environmental conditions such as temperature, humidity, lighting, sound levels, etc. affect comfort levels of an occupant of a location. Environmental control systems and devices are increasingly complex, many being wirelessly controllable. Managing a complex network of environmental control systems/devices under varying conditions is a challenge. The challenge becomes more complex when multiple people with different preferences are in the same space.

### SUMMARY

The present disclosure generally describes techniques for dynamic optimization of environmental controls.

According to some examples, a method for dynamic environment control may include generating a temporal environmental control model for a person based on one or more of a preference of the person, a current activity of the person, or a recent activity of the person; generating a temporal location model for the person, where the temporal location model includes a current location of the person and predicted future locations of the person; receiving information associated with one or more of architectural parameters, current environmental parameters, and available environmental control devices associated with the current location or predicted future locations of the person; generating instructions for one or more environmental control devices at the current location and/or a predicted future location to set environmental parameters based on the temporal environmental control model and the temporal location model; and transmitting the instructions to the one or more environmental control devices for execution.

According to other examples, a controller configured to dynamically control environmental conditions may include a communication device configured to communicate with one or more environmental control device, environmental sensors, and computing devices; a memory configured to store instructions; and a processor coupled to the communication device and the memory. The processor, in conjunction with the instructions stored on the memory, may be configured to generate a temporal environmental control model for a person based on one or more of a preference of the person, a current activity of the person, or a recent activity of the person; generate a temporal location model for the person, where the temporal location model includes a current location of the person and predicted future locations of the person; receive information associated with one or more of architectural parameters, current environmental parameters, and available environmental control devices associated with the current location or predicted future locations of the person; generate instructions for the one or more environmental control devices at the current location and/or a predicted future location to set environmental parameters based on the temporal environmental control model and the temporal location model; and transmit the instructions to the one or more environmental control devices for execution.

According to further examples, an environmental control system (ECS) may include one or more environmental control devices associated with a location; one or more environmental sensors associated with the location; and a controller communicatively coupled to the one or more environmental control devices and environmental sensors. The controller may be configured to generate a temporal environmental control model for a person based on one or more of a preference of the person, a current activity of the person, or a recent activity of the person; generate a temporal location model for the person, where the temporal location model includes a current location of the person and predicted future locations of the person; receive information associated with one or more of architectural parameters, current environmental parameters, and available environmental control devices associated with the current location or predicted future locations of the person; generate instructions for the one or more environmental control devices at the current location and/or a predicted future location to set environmental parameters based on the temporal environmental control model and the temporal location model; and transmit the instructions to the one or more environmental control devices for execution.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes an architectural illustration of a home, where environmental control systems may be dynamically managed;

FIG. 2 includes an illustration of an example room with various environmental control elements, sensors, and configurations;

FIG. 3A and 3B include illustrations of example dynamic environmental control scenarios;

FIG. 4A through 4C include example components and actions for a dynamic environment control system;

FIG. 5 illustrates major components of an example system for dynamic environment control system;

FIG. 6 illustrates a computing device, which may be used to manage a dynamic environment control system;

FIG. 7 is a flow diagram illustrating an example method for dynamic environment control that may be performed by a computing device such as the computing device in FIG. 6; and

FIG. 8 illustrates a block diagram of an example computer program product, all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to dynamic optimization of environmental controls.

Briefly stated, technologies are generally described for dynamic optimization of environmental controls. A system according to some examples may determine a person's environmental preferences and generate a time-based environmental control model for that person. The system may also generate a location model defining current and predicted future locations for the person. The environmental model may take into account person's previous or current activity and be adjusted based on sensed data from interior and exterior environmental sensors and body sensors on the person. Models for multiple people may be combined based on priorities or personal characteristics. Models may also be stored in mobile devices such that settings can be implemented in future locations prior to arrival of the person. Implemented settings may be adjusted for additional people as they arrive at the location.

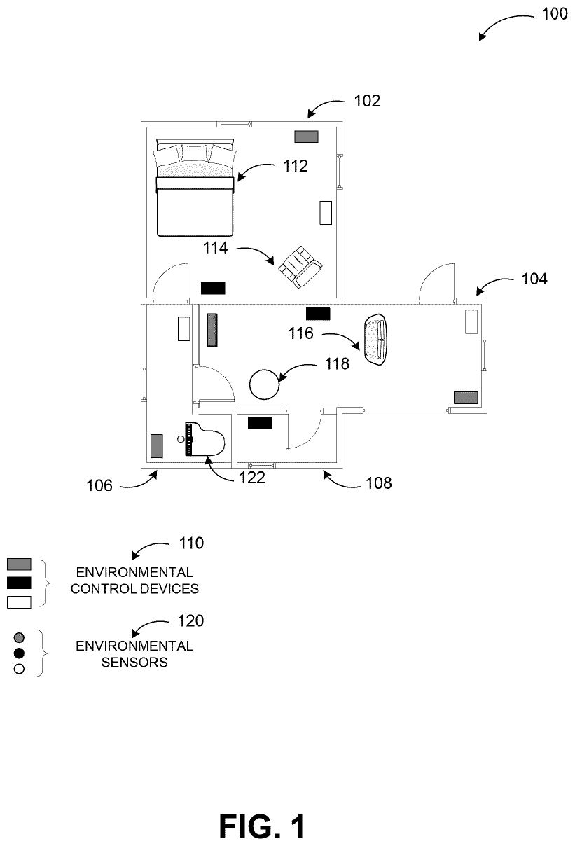

FIG. 1 includes an architectural illustration of a home, where environmental control systems may be dynamically managed, arranged in accordance with at least some embodiments described herein.

Diagram 100 shows a home, which may include a bedroom 102, a living room 104, a study 106 and a kitchen 108. Each room in the home has example furniture such as bed 112, chair 114, couch 116, table 118, piano 122, etc. Environmental control in the home may include management of temperature, humidity, lighting, sound levels, shading, and similar ones provided by environmental control devices 110, each of which may manage one or more different aspects (e.g., temperature and humidity). Current environmental conditions may be determined through environmental sensors 120 dispersed throughout the home and exterior to the home.

Comfort at home or in the office depends on many parameters (temperature, humidity, light brightness and color, odor, sound, etc.), and each building may have multiple occupants at the same time, with different needs and preferences, dispersed in different rooms or together in the same room. Embodiments are directed optimization of the home environment for all occupants to ensure the optimal comfort while reducing energy consumption. Energy consumption may be achieved, for example, by turning off or reducing an operation of one or more environmental control devices when no people are present, coordinating operation of or selecting specific environmental control devices to minimize energy usage for a specific environmental setting, etc. For example, if a person is watching TV, the ECS may adjust the brightness of the TV a little higher and turn off some lights in the room reducing total consumed energy. The optimization may be adjusted when other people such as outside guests come into the building.

In managing the environment aspects such as dimensions of each room, size and placement of furniture in each room, size and placement of windows and doors, number and placement of environmental control devices, current conditions in each of the rooms, outside conditions (e.g., lighting, shading, outside temperature/humidity, etc.) may be taken into consideration. Furthermore, desired environmental conditions and how to reach the desired environmental conditions from the current conditions may be parameters in determining how to manage the environmental controls.

The environmental control devices 110 may control one or more of a temperature, a humidity, an air flow speed, a lighting level, a lighting composition, a sound level, or a sound composition for each of the rooms or the entire home. The environmental control devices 110 may also encompass controls of devices that can provide light, sounds, etc. into the environment such as sound or brightness controls of a TV, room light level and composition controls, and any other electrical device control that may contribute to the environment at the location. The environmental sensors 120 may include a temperature sensor, a humidity sensor, a sound sensor, a light detection sensor, an air flow sensor, or a user input device, for example.

The home in diagram 100 is an illustrative example for a location, where embodiments may be implemented, but is not intended to limit embodiments. Other locations may include, but are not limited to, an office, a school, a health care facility, a hotel, a factory, or comparable buildings, as well as, a vehicle such as an automobile, a bus, a recreational vehicle, an airplane, a ship, and similar ones.

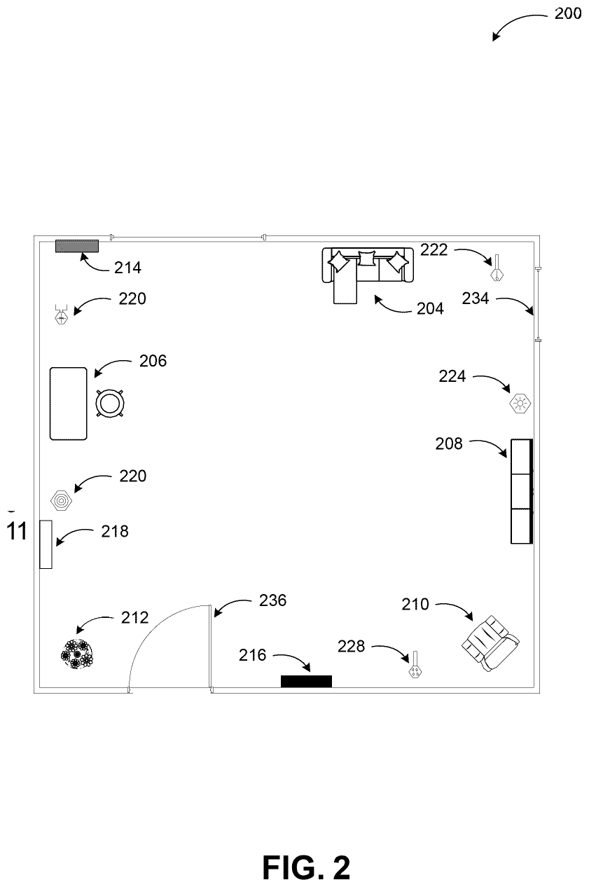

FIG. 2 includes an illustration of an example room with various environmental control elements, sensors, and configurations, arranged in accordance with at least some embodiments described herein.

Diagram 200 shows a room with door 236 and windows (e.g., window 234). The example room also includes furniture such as couch 204, library 208, chair 210, table 206, and indoor plant 212. To implement a system for dynamic control of the room environment, the room may be equipped with a variety of environmental control devices such as temperature/humidity controller (e.g., heat/cold exchanger) 214, lighting controller (e.g., LED light source) 218, and sound controller 216. Various environmental sensors such as thermometer 222, airflow sensor 220, light sensor 224, humidity sensor 220, and microphone 228 may be used to detect current conditions in the room and monitor changes in the environmental characteristics.

In one example, a controller (not shown) may employ a time-based environmental control model for person. For example, the person may be taking a nap on the couch 204, and the model may define specific environmental control values (over time) to awaken the person. The controller may instruct appropriate devices to provide suitable music or noise (e.g., pink noise) in a steadily increasing level into the room. The level of sound may be detected by the microphone and fed back to the controller, so that the controller can adjust levels. Furthermore, a camera or similar sensor may detect movement or lack thereof of the person indicating whether the person is awake or not and provide feedback to the controller for further adjustment of the sound levels. For example, if the camera detects the person waking up from sleep, the sound levels may be gradually increased. On the other hand, if the person lays down to sleep, the system may gradually decrease the sound levels (and/or composition) for an easier transition to sleep in response to detection of the laying down by the camera. Of course, multiple environmental characteristics such as lighting and temperature levels may also be adjusted in combination with the sound levels for a smooth awakening or easy falling asleep of the person.

In another example, the person may be working at the table 206. The controller may adjust one or more environmental characteristics using appropriate environmental control devices and receiving feedback from suitable sensors to keep the person alert. That is, the temperature, lighting, sounds level, etc. may not be allowed to reach levels, where the person may be too comfortable and fall asleep.

In a further example, the controller may determine that the person has arrived home after jogging. That means, the person's body temperature is likely to be higher than normal. Thus, the controller may instruct heat/cold control devices to lower the home temperature for a suitable period and then bring back to the person's preferred temperature range or in response to detecting the person's body temperature return to normal.

Aspects of example embodiments may include, but are not limited to, applicability to different environments such as residences, office buildings, hotels, schools, and others including individual offices, shared offices, conference rooms, etc.; learning a comfort model for each particular person, and then combining results of the models for different people to determine optimal settings for the home dynamically allowing matching of people's needs, as well as, portability when people move from one environment to another. A system according to embodiments learns a location model for each person to allow for predictions of which group of people may be in each location in any given time period and prepare the optimal environment for them. The system may take into account priority/seniority of different people at each location (e.g., elderly, temporarily sick, tired, guests in home or office, etc.). The system may identify and prepare for upcoming guests and their preferences. For example, the ECS may connect to a guests' ECS and acquire the guests' preferences. Personal ECS preferences may also be stored on a mobile device such as a smart phone; when user travels, the device may connect to a local ECS to include user preferences into the environment optimization process. The environment optimization process may also include optimization for energy consumption.

An environment, where embodiments may be implemented, may include a multitude of environmental control devices, including but not limited to, heating devices, air conditioners, humidifiers, actuated window shades, climate control, light and sound devices (lights, speakers, TVs, etc.), vents, odor generators, and many others. Such devices may be Internet of Things (IoT) enabled and communicate over high-speed links (for example, but not limited to, 4G, 5G, WiFi, etc.). The ECS may be connected to all available environmental control devices, and may also be in communication with wearable devices that the people carry such as cellular phones, smart glasses, watches, bracelets, and others that can sense a person's motion, temperature, heart rate, perspiration, pupil size, stress level, etc.

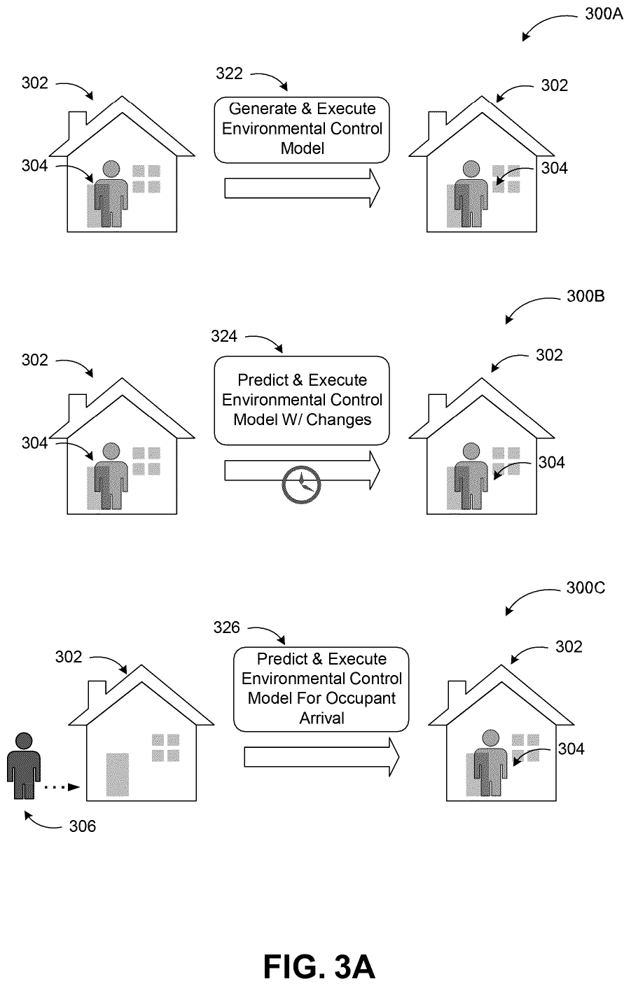

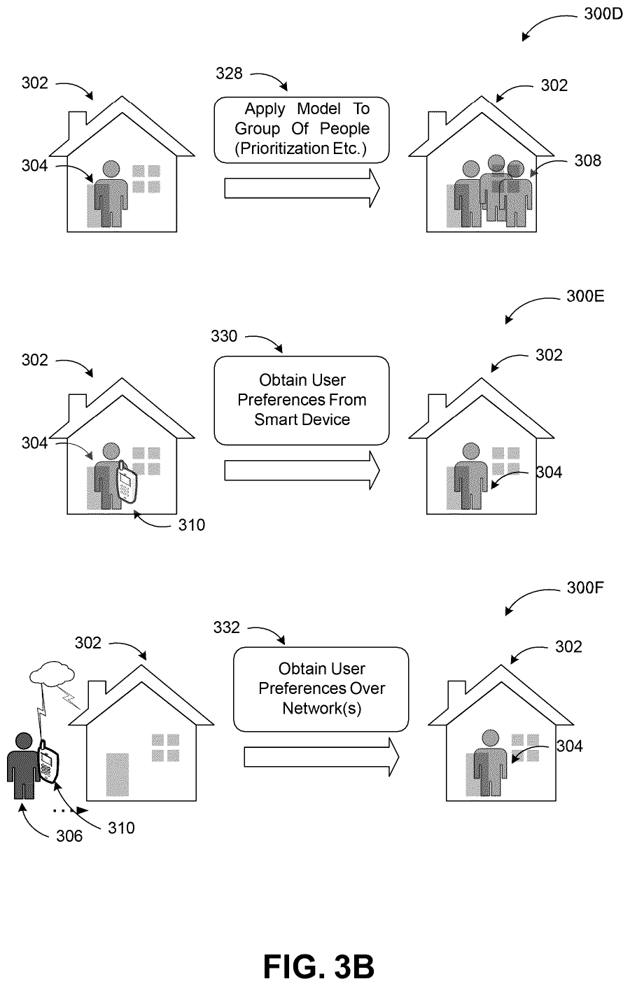

FIG. 3A and 3B include illustrations of example dynamic environmental control scenarios, arranged in accordance with at least some embodiments described herein.

Diagram 300A in FIG. 3A shows an example scenario, where an environmental control system (ECS) generates (322) a static environmental control model for a person 304 at a location (e.g., home 302) based on one or more of a preference of the person, a current activity of the person, or a recent activity of the person. The model may define environmental parameters to set the environment in the home 302 according to the person's preferences based on other factors such as previous or current activities, person's biological characteristics (e.g. blood pressure, heart rate, etc.). The model may then be executed by the ECS instructing various environmental control devices in and around the home 302.

Diagram 300B in FIG. 3A shows another example scenario, where the ECS generates (324) a temporal environmental control model for a person 304 at home 302 based on one or more of a preference of the person, a current activity of the person, or a recent activity of the person. The time-based model may define environmental parameters to set the environment in the home 302 according to the person's preferences over time. For example, the person may prefer the temperature, lighting levels, and sound levels to be set to different values in the morning, in the afternoon, and in the evening. The model may then be executed by the ECS instructing various environmental control devices in and around the home 302 at the specified times. The model may also be adjusted based on changes (e.g., in the person's physical characteristics such as body temperature, heart rate, alertness level, etc., as well as, external temperature, humidity, light level changes). The ECS may predict needed environmental parameters such as temperature, humidity, air flow speed, lighting level, lighting composition, sound level, smell, and/or sound composition based on the model and any changes and execute by instructing the environmental control devices.

Diagram 300C in FIG. 3A shows a further example scenario, where the ECS generates or receives (326) a temporal environmental control model for a person 306 along with a temporal location model for the same person. Based on the models, the ECS can predict or detect when the person 306 is arriving at the home 302. The person 306 may be the same as the person 304 simply arriving at home or a different person (e.g., a guest or a second occupant of the home 302). The ECS may set/adjust environmental settings at the home 302 similar to the described processes above, but with the time of arrival being taken into account. For example, if the home is cold and needs to be heated by 10 degrees or more, the ECS may instruct the environmental control devices to start heating the home ahead of the person's arrival. On the other hand, desired lighting or sound levels may be implemented at the time of arrival.

In some examples, the ECS may have higher granularity to control environmental settings in different rooms or even different portions of a room. Through motion sensors, cameras, and similar detection devices, the ECS may detect movement of the person inside the home and adjust environmental settings for different portions according to the model. For example, the system may determine that the person typically goes to the kitchen around 6.30 pm to prepare dinner and set the environmental parameters in the kitchen for 6.30 pm. Supervised or unsupervised machine learning algorithms may be employed to generate/adjust the model(s).

Diagram 300D in FIG. 3B shows a scenario, where a generated (or received environmental control model is applied to a group of people (328). For example, multiple models may be generated for a number of people such as person 304 at home 302. When a group 308 of those people gather at the home 302, the ECS may combine the models by assigning or considering priorities assigned to different people, personal characteristics, etc. In one example, the ECS may generate models for occupants of the home and receive a model generated by another system for a guest that arrives at the home.

The ECS may assign (or be provided) priorities to people based on their importance, age, health conditions, etc. For example, the system may listen to the people in the home through microphones and apply speech recognition. The system may hear a person say “Grandfather is not feeling well today, we need to take care of him”. The system may deduce from this conversation that grandfather is to be prioritized and give more weight to the preferred environmental parameters for the grandfather. The system may deduce this due to the grandfather's age, deferring to his status as an elder, his temporary illness, or both. In other examples, the preferred environmental parameters for each person may be combined through a weighted approach that may take into account current conditions of each person (e.g., their body temperature, heart rate, etc.). If the people are at different locations around the home 302 and environmental control can be managed with higher granularity, different locations within the home may be controlled according to who is at that location. In some examples, combination of models for group of people may be implemented through a rule-based system. The rule-based system may include predefined and/or machine learning adjustable rules that define what happens when specific people get together or what happens when preferences of two or more people collide.

In another example, cameras monitor not just simple measurable events like people's presence or body temperature, but also behaviors that may be interpreted to indicate environmental (dis)comfort from moves and gestures (e.g., putting a sweater on, a shiver, or rubbing/warming hands, etc.). Machine learning systems may learn what such gestures mean for each person as they differ from person to person.

Diagram 300E in FIG. 3B shows another scenario, where environmental preferences or a pre-generated environmental control model for a person 304 may be stored on a mobile device 310 associated with the person such as a smart phone, a smart watch, a wearable computer, etc. As the person 304 arrives at the home 302, the model may be retrieved from the mobile device 310 by the ECS and executed. For example, the model may be retrieved from the mobile device as the mobile device enters a range of a wireless network of the home 302 or through other means.

Diagram 300F shows a further scenario, where a pre-generated environmental control model or environmental preferences of a person 306 may be received by the ECS over a network as the person approaches or plans to arrive at the home 302. For example, the pre-generated model may be stored at the person's mobile device 310. Upon detecting the person heading toward the home (e.g., based on a location service) and passing through a predefined threshold (e.g., 3 miles, 5 miles, etc.), the ECS may retrieve the model from the mobile device 310 and implement for when the person is in the home. In other examples, the pre-generated model or personal preferences may be stored in the cloud and retrieved by the ECS either under a similar scenario as described above or based on the person's calendar indicating when the person should be expected at the home.

As discussed above, various interior or exterior environmental sensors may be used to sense environmental conditions inside and outside the home and adjust the environmental control models accordingly. Similarly, biometric sensors measuring blood pressure, heartbeat, body temperature, body movements, eye movements, etc. may be used to determine a comfort or an alertness level of the person inside the home and the implemented model adjusted accordingly.

While the example scenarios in FIG. 3A and 3B are described in a home, an ECS according to embodiments may be implemented at an office, a school, a health care facility, a hotel, a factory, etc. as well. Embodiments may also be implemented in mobile locations such as an automobile, a bus, a recreational vehicle, an airplane, a train, or a ship. For example, in an airplane different environmental control zones may be established for each row of seats, groups of rows, of even individual seats, along with the flight cabin. In further examples, dynamic environmental control may be implemented in animal transportation vehicles (or stationary animal storage buildings). Different species may respond differently to varying environmental conditions. Depending on which species (e.g., cattle, sheep, poultry animals) are being transported, the environmental controls may be managed as discussed herein. The same approaches may be used for visitors to an office as well. the ECS for an assigned conference room may connect to the smart phones of the visitors to acquire their environmental preferences models that may be considered in the environmental optimization process for the conference room for the upcoming time period. In addition, at least some of the guests may be considered of higher importance than the hosts, and the ECS may take these hierarchy rankings into account too.

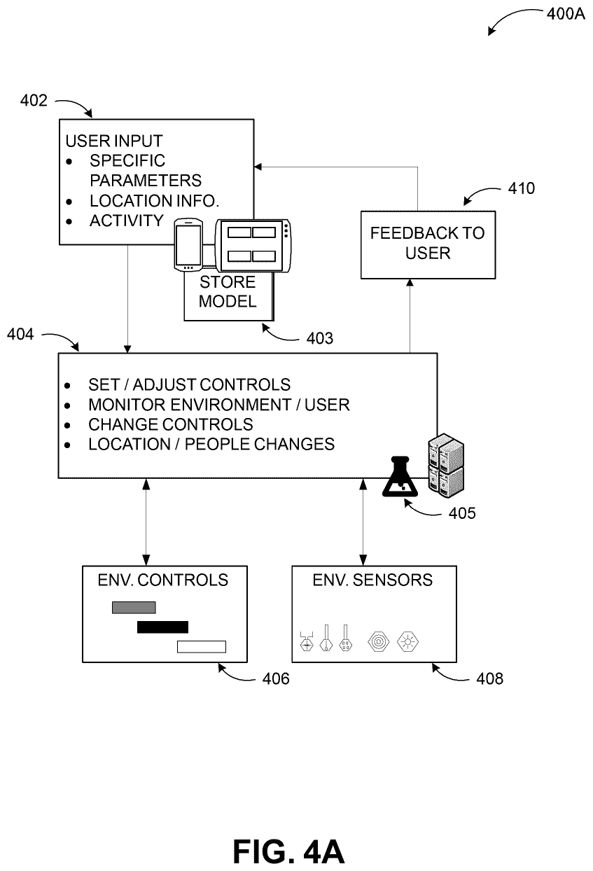

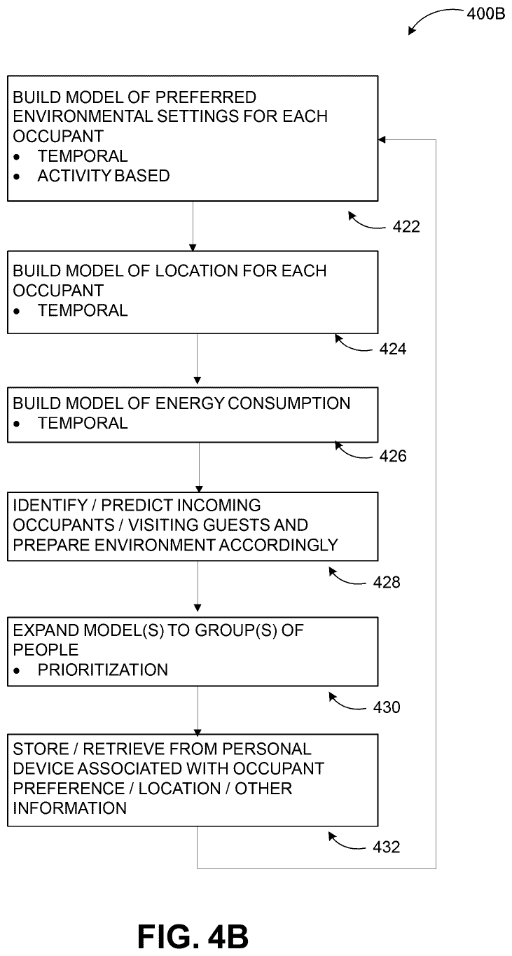

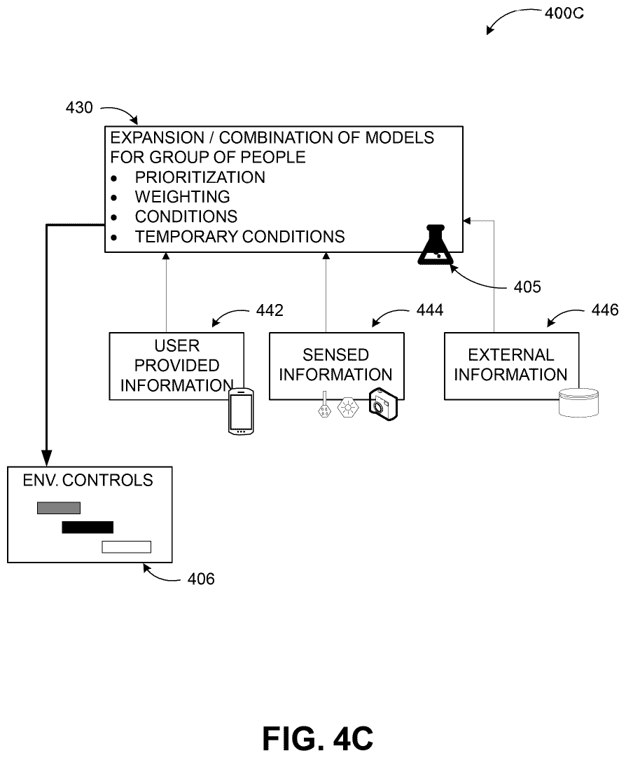

FIG. 4A through 4C include example components and actions for a dynamic environment control system, arranged in accordance with at least some embodiments described herein.

Diagram 400A of FIG. 4A shows major actions by different components of a system according to embodiments. For example, users (or occupants) may be allowed to provide input (402) such as specific environmental parameters, location information, activity information, or select among a set of predefined scenarios through an environmental control device user interface or a computing device. An application or a browser-based access to the system may allow a user to provide their input at the location that is controlled for its environment or from any location using any computing device. A server or controller 404 (e.g., a special purpose device) may then generate or adjust a temporal environmental model and/or a location model, through which environmental control parameters may be defined or changed, the environment at the location may be monitored, and biologic functions of the occupant(s) monitored. Location and/or people changes at the location may also be monitored to adjust the implemented models. The server or controller 404 may employ supervised or unsupervised machine learning 405 to generate and implement the models. In some examples, the environmental control model or user preferences may be stored at a mobile device 403 associated with each person to be retrieved by the server or controller in order to be implemented. The server or controller may control operations of various environmental control devices 406 and receive input/feedback from a number of environmental sensors 408. The server may also provide feedback 410 to the user through the environmental control device or the user's computing device.

Environmental control parameters associated with the location may be received from an environmental control device, a desktop computer, a handheld computer, a smart phone, a smartwatch, a vehicle-mount computer, or a remote server. The environmental control parameters may specify values or range of values for a temperature, a humidity, an air flow speed, a lighting level, a lighting composition, a sound level, or a sound composition for the location. The environmental control devices may include a heating element, a cooling element, an air flow element, a light source, a shading controller, a tinting controller, or a sound source. The environmental sensors may include a temperature sensor, a humidity sensor, a sound sensor, a light detection sensor, an air flow sensor, or a user input device. The environmental sensors may also include a microphone or a laser anemometer, which may be used to measure the distribution of air speed at the location. The environmental sensors may further include an ultrasound transducer and receiver to measure air speed through Doppler effect. In another example, the environmental sensors may include a camera, which may monitor air speed by detecting vibrations in the furniture, lamps, curtains, etc. The camera may also be a thermal camera to measure temperature by measuring the location's diffusive heat pattern.

The system may receive current environmental conditions for the location from one or more environmental sensors and/or from external sources such as a database. The architectural parameters may include, but are not limited to, dimensions of the location, wall/floor/ceiling composition, sizes and placement of furniture in the location, sizes and placement of doors and windows. External conditions such as outside temperature/humidity, outside lighting (composition and level), outside sound composition and level may also be factored into the generation/adjustment of the models to be executed.

Diagram 400B of FIG. 4B shows some example actions performed by one or more servers of a system to dynamically control environmental conditions according to some embodiments. The server(s) may be a specialized server, mainframe, or similar computer and may be implemented as a standalone, single device, as a distributed computing system, multiple computers co-working with each other, etc. Major operations may be performed by a number of components. For example, a component may build the environmental control model of environmental settings for each person (422). The model may be temporal (time-based) and/or activity based taking into consideration a person's current or previous activities (e.g., a person coming home from running or other strenuous activity may have different environmental preferences compared to another person coming from a long wait outside in the cold). Another component may build the location model for each person defining the person's current or predicted future locations (424). Thus, the location model is also temporal. The location model may take into account movements such as going from the home office in the afternoon to the kitchen, to the dining room, to the living room, or to the bedroom at night. The location model may be built from direct observation and may be altered if the ECS has access to the person's calendar. Yet another component may build a model of energy consumption (426) based on the environmental control and location models (temporal). In some examples, the implementation of the environmental control model may be adjusted based on energy consumption considerations. A further component may identify or predict incoming occupants or guests and combine different models for different people or adjust an implemented environmental control model (428). Another component may be used to expand the generated or received models to groups of people (430) by, for example, prioritizing people in the group, considering personal characteristics and conditions of the people in the group, etc. And yet another component may store or retrieve generated environmental control model(s), personal preference information, location information, etc. from mobile devices associated with people (432).

The environmental control and location models may be continuously adjusted using supervised and unsupervised machine learning technology. Such models allow for better tuning of the environmental parameters in a dynamic fashion, rather than a static preparation of the environment (i.e., always the same for the same set of people). One method of unsupervised learning for training the preference model is to correlate the person's body temperature, motion state, heart rate, perspiration level to the environmental control parameters. As an example, a deduction may be made that if a person is restless (at rest or during sleep), which can be observed by computer vision or sensors in the person's phone, smart glasses, etc., then the person is not in a comfortable state. At each time period, the ECS may predict, for the next time period, who will be in each room (and if possible where in the room, with finer granularity—for example, some people prefer a certain chair or place on the sofa to watch TV in the evening, or a certain place at the dinner table, or a certain place at a conference table, etc.). The ECS may then use the model of preferred environmental settings for that person and time as input to the environmental setting algorithm.

Artificial Intelligence (AI) algorithms control any device that perceives its environment and takes actions that maximize its chance of successfully achieving predefined goals such as optimizing environmental parameters at a location based on a person's preferences, conditions, etc. A subset of AI, machine learning (ML) algorithms build a mathematical model based on sample data (training data) in order to make predictions or decisions without being explicitly programmed to do so. In some examples, an AI planning algorithm or a specific ML algorithm may be employed to determine current and desired environmental parameters, predict future environmental settings, etc. and provide instructions for environmental control devices to achieve the desired/predicted environmental settings. The environmental setting algorithm may be triggered by the system when environmental settings (e.g., temperature or lighting levels) change, a request by the person, a predicted arrival of the person or other people, etc. The person may also allow ML (training) data to be uploaded to a network so that other users can benefit from their data. The ML algorithm may facilitate both supervised and unsupervised learning.

When determining the person's preference for the next time period, the previous activity for that person may be determined from a multitude of sources, for example, the person's calendar if available and updated, direct observation if available through a camera or microphone, or from communicating with the person's smart phone which can know that the person has been running for the past 20 minutes or has been standing in a cold place, etc. The location may have computer vision devices including infrared vision devices that can monitor the person's body temperature and perspiration level and adjust the environmental control parameters accordingly. Based on the prediction for each person that will likely occupy a room in the next time period, the ECS may prepare the room's environment. In group scenarios, the ECS may account for the priority/seniority of each person in the room, as well as, reduction of energy consumption, to obtain the set of optimal environmental settings. The comfort level for the entire set of people may be maximized as a weighted function of individual comfort. In some examples, the ECS may continuously adjust the settings to the actual people in the room and learn various aspects of the home environment optimization process (people location model, preferred settings vs time model, etc.).

Guests may be identified from available resources like accessible calendars, from learned models that identify somewhat regular events (e.g., book club, games, playdates, etc.), or from direct input by a host that communicates to the ECS that certain guests are coming at a certain time. To acquire the environmental preferences of these guests, the host ECS may connect to the guests' ECS(s) and acquire the guests' preference models, which may be used as input into the optimization algorithm. The optimization algorithm may be an AI or ML algorithm designed to combine and optimize different people's environmental setting models for particular locations.

As discussed previously, the ECS environmental control (preference) model of a person may be stored on the person's smart phone. When the person travels, the smart phone may connect to the local ECS to include its preference model into the environment optimization process. Alternatively, the smart phone may include knowledge of many upcoming locations for its user (from the calendar and other sources—for example, the smart phone itself may build a model of its user's locations at different times of day/week/month/year, and use that to predict its user's location in the next time period). The smart phone may connect to the ECS of a predicted upcoming location for its user and transfer to that ECS its environmental preferences model to be considered in the environmental optimization process for that upcoming time period.

Simplicity and ease of use of a system according to embodiments may be further enhanced by comprehensive use of available sensors that may be fused seamlessly. For example, computer vision techniques may be used to detect a person's behavior and correlate with the person's physiological parameters such as body temperature, heart rate, perspiration levels, etc. to automatically adjust the system. In another practical example, the system may detect a person adjusting his/her clothing (e.g., unbutton vs. button up, wiping sweats, coving with a blanket while sleeping) and detect that the person is too warm or too cold and direct the environmental control devices to adjust the environmental parameters accordingly.

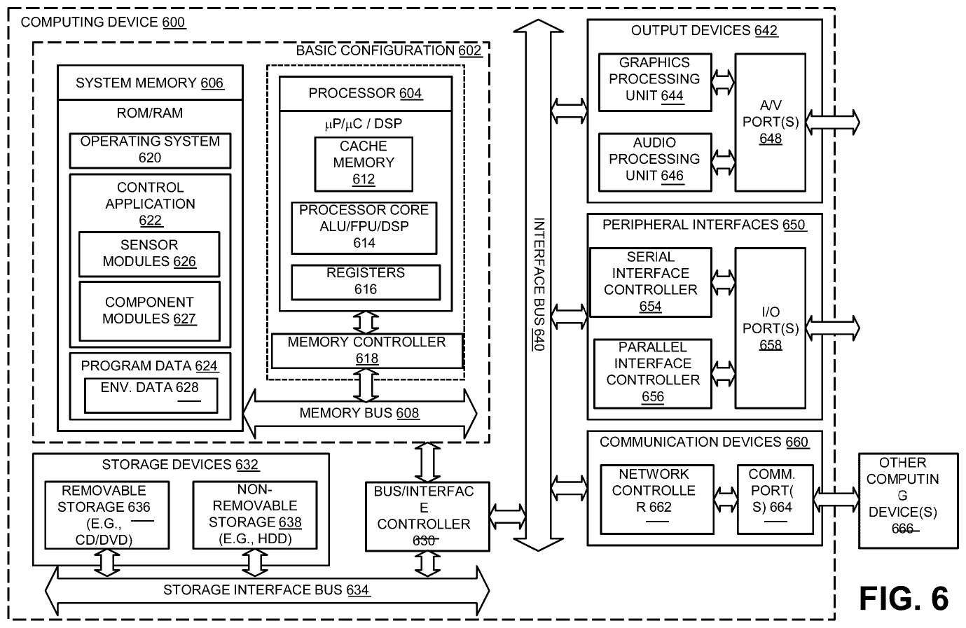

Diagram 400C of FIG. 4C shows expansion or combination of models for more than one person at a location (430). A machine learning (405) based system may combine multiple individual models for the people together at the location (e.g., retrieved from their mobile devices or from a data store 446). In other examples, the system may start with a single person model and expand the model to multiple people. The expansion/combination may take into account a priority of the individual people (e.g., age seniority, organizational position seniority, social seniority, etc.), assign weights to physical, behavioral, positional characteristics of the people, continuous conditions associated with the people (e.g., permanent health conditions), temporary conditions (temporary illnesses, recent or current activities, etc.), and comparable factors. The system may receive information from user devices 442 (user provided information), sensors 444 (sensed information such as captured and analyzed images, videos, sounds), and external data stores 446. Upon expanding a model or combining multiple models, the system may provide instructions to environmental control devices 406 in order to implement the newly computed model. Data store 446 and other data stores mentioned herein may be any form of data storage as discussed in conjunction with FIG. 6 below.

The components described above are for illustration purposes. Each of the example components may be executed at a separate server (or special purpose machine), some components may be executed at the same server, or all components may be executed at the same server. The components may also be executed in a distributed manner at the cloud. Additionally, some of the operations discussed above may be combined at the same component or a single operation may be performed by more than one component. For example, different components may be employed to generate location models for a home, for an office, etc. Alternatively, the same component may be used to generate all three models.

In another example, a user may provide operating parameters, for example, using a screen input or moving to various locations in the room and providing temperature and air movement setting at each location. The system may alert the user if one or more parameters are not attainable or are in contradiction. Alternatively, the user may download a suggested setting or edit a suggested setting. The system may monitor the room using temperature sensors and air speed sensors and adjust the action of the air conditioner, fans, heaters, etc. according to the user provided/adjusted setting. In the varying in space example, limitations in spatial distribution may be learnt by the system after installation through a self-calibration.

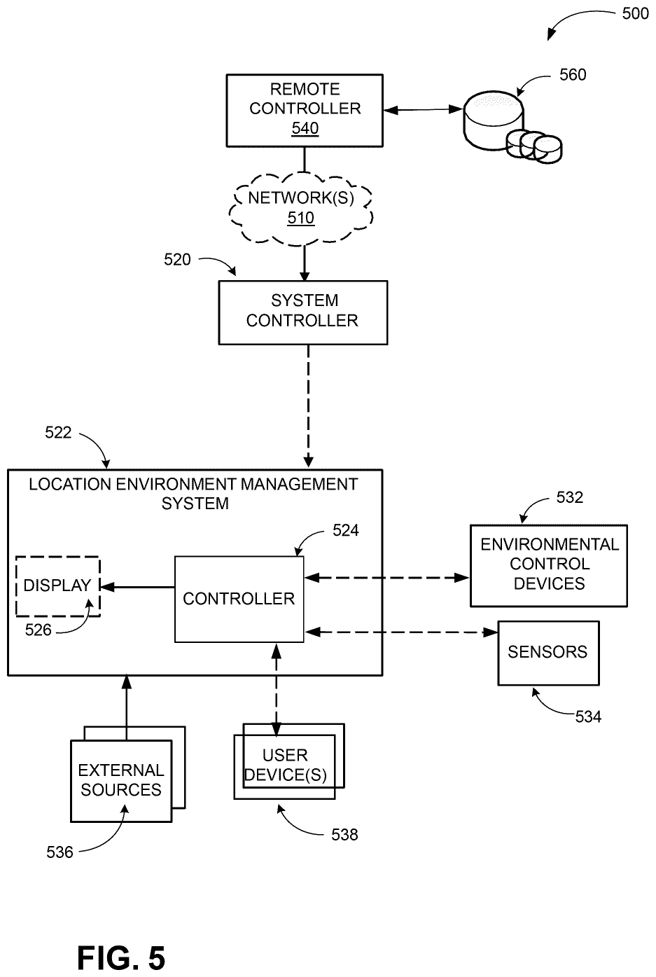

FIG. 5 illustrates major components of an example system for dynamic environment control system, arranged in accordance with at least some embodiments described herein.

Some embodiments may include a system configured to provide dynamic environment control. An example system as shown in diagram 500 may include a remote controller 540 communicatively coupled to data stores 560 and to a system controller 520 over one or more networks 510. The remote controller 540 and the system controller 520 may be individual, distinct servers working separately or co-working in a distributed fashion. They may also be part of a system of multiple processors performing parallel processing. The controllers may communicate of one or more networks 510 to perform all or part of the tasks associated with dynamic environmental control as described herein. For example, the remote controller 540 and the system controller 520 may control multiple location environment management systems. The system may also include a location environment management system 522. The location environment management system 522 may include a controller 524 coupled to an optional display 526 to provide information to a person or people at the location. The location may include a home, an office, an educational location, a health care location, or similar stationary locations. The location may also include a mobile location such as a car, a truck, a van, a bus, a boat, a plane, etc.

The location environment management system 522 may receive information associated with a preference of the person, a current activity of the person, and/or a recent activity of the person, and generate a time-based environmental control model for the person. The location environment management system 522 may also generate a temporal location model for the person that defines a current location of the person and predicted future locations of the person. Based on the models and other information such as architectural parameters, current environmental parameters, and available environmental control devices associated with the current location or predicted future locations of the person, the location environment management system 522 may generate instructions for environmental control devices 532 to implement the environmental control model. The location environment management system 522 may receive input from sensors 534 (e.g., environmental sensors interior or exterior to the location, body sensors for the sensor), user devices 538 (e.g., mobile or wearable devices), and external sources 536 (e.g., databases, environmental data sources, etc.).

In some examples, dynamic environment control management operations may be performed by a controller and instructions for specific actions sent to a local controller. In other examples, the dynamic environment control management operations may be performed at the local controller. In yet other examples, a central controller (or server) may transmit multiple scenarios to environmental controllers on location and those controllers may execute the instructions.

FIG. 6 illustrates a computing device, which may be used to manage a dynamic environment control system, arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a control application 622, and program data 624. The control application 622 may include sensor modules 626 and component modules 627. The control application 622 may be configured to receive information associated with a person such as their environmental setting preferences, location(s), activities, etc., as well as, location specifics such as physical characteristics, environmental settings, available environmental control devices associated with a current location and predicted future locations. The application may generate temporal environmental control and location models to generate instructions for individual environmental control devices at the location to create environmental settings according to the person's preferences and other parameters. The program data 624 may include environmental data 628 such as climate, lighting, sound environment, and similar data for the location, among other data, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 660 includes a network controller 662, which may be arranged to facilitate communications with one or more other computing devices 666 over a network communication link via one or more communication ports 664. The one or more other computing devices 666 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 600 may be implemented as a part of a specialized server, mainframe, or similar computer that includes any of the above functions. The computing device 600 may also be implemented as a personal computer including both laptop computer and non-laptop computer configurations.

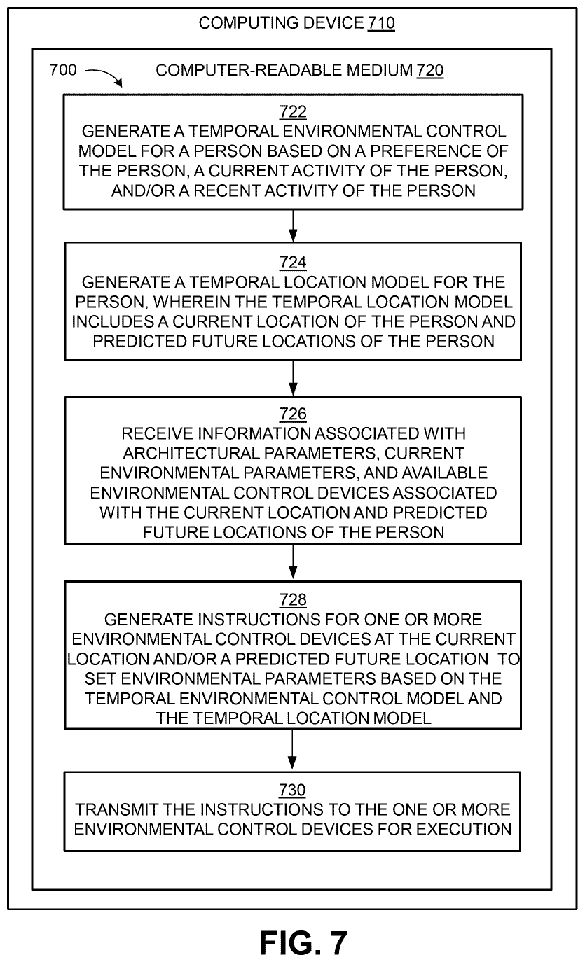

FIG. 7 is a flow diagram illustrating an example method for dynamic environment control that may be performed by a computing device such as the computing device in FIG. 6, arranged in accordance with at least some embodiments described herein.

Example methods may include one or more operations, functions, or actions as illustrated by one or more of blocks 722, 724, 726, 728, and 730 may in some embodiments be performed by a computing device such as the computing device 600 in FIG. 6. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 722-730 may be implemented through execution of computer-executable instructions stored in a computer-readable medium such as a computer-readable medium 720 of a computing device 710.

An example process to provide dynamic environment control may begin with block 722, “GENERATE A TEMPORAL ENVIRONMENTAL CONTROL MODEL FOR A PERSON BASED ON A PREFERENCE OF THE PERSON, A CURRENT ACTIVITY OF THE PERSON, AND/OR A RECENT ACTIVITY OF THE PERSON”, where a controller or an control application 622 may build a temporal model of preferred environmental settings for a person based on their preferences, a current activity, a recent activity, or other information at a location such as a home, an office, a school, a health care facility, a hotel, a factory, or comparable buildings, as well as, a vehicle such as an automobile, a bus, a recreational vehicle, an airplane, a ship, or similar ones. The environmental control settings may be associated with climate, lighting, sounds, shading, tinting, etc. within the location.

Block 722 may be followed by block 724, “GENERATE A TEMPORAL LOCATION MODEL FOR THE PERSON, WHERE THE TEMPORAL LOCATION MODEL INCLUDES A CURRENT LOCATION OF THE PERSON AND PREDICTED FUTURE LOCATIONS OF THE PERSON”, where the control application 622 may generate (or receive) a time-based location model for the person. The model may define where the person currently is, how long they are expected to remain at the location, where they may be in the future, for how long, etc. The model may have high granularity, that is, it may define which room within a building the person is or expected to be. The temporal location and environmental control models may be generated and continuously adjusted using supervised or unsupervised machine learning technology.

Block 724 may be followed by block 726, “RECEIVE INFORMATION ASSOCIATED WITH ARCHITECTURAL PARAMETERS, CURRENT ENVIRONMENTAL PARAMETERS, AND/OR AVAILABLE ENVIRONMENTAL CONTROL DEVICES ASSOCIATED WITH THE CURRENT LOCATION OR PREDICTED FUTURE LOCATIONS OF THE PERSON”, where the control application 622 may receive information associated with physical characteristics of the location, current environmental parameters (e.g., temperature, humidity, lighting level, sound level, etc.). The control application 622 may also receive similar information for future locations predicted by the temporal location model.

Block 726 may be followed by block 728, “GENERATE INSTRUCTIONS FOR THE ENVIRONMENTAL CONTROL DEVICES AT THE CURRENT LOCATION AND/OR A PREDICTED FUTURE LOCATION TO SET ENVIRONMENTAL PARAMETERS BASED ON THE TEMPORAL ENVIRONMENTAL CONTROL MODEL AND THE TEMPORAL LOCATION MODEL”, where the individual component modules 627 or the control application 622 may control or transmit instructions to control one or more environmental control devices in order to execute the instructions such that the generated environmental control models can be implemented at the location (or future locations).

Block 728 may be followed by block 730, “TRANSMIT THE INSTRUCTIONS TO THE ENVIRONMENTAL CONTROL DEVICES FOR EXECUTION”, where the individual component modules 627 or the control application 622 may control or transmit instructions to control one or more environmental control devices in order to be executed, for example, change of temperature, humidity, lighting level, sound levels, etc. at the location.

The operations included in process 700 are for illustration purposes. Dynamic environment control may be implemented by similar processes with fewer or additional operations, as well as in different order of operations using the principles described herein. The operations described herein may be executed by one or more processors operated on one or more computing devices, one or more processor cores, and/or specialized processing devices, among other examples. In further examples, parallel processing may be employed, computations or the execution of processes may be carried out simultaneously by one or more processors dividing large tasks into smaller ones and solving at the same time. Tasks split for parallel processing may be controlled by necessary elements. Different types of parallel processing such as bit-level, instruction-level, data, and task parallelism may be used.

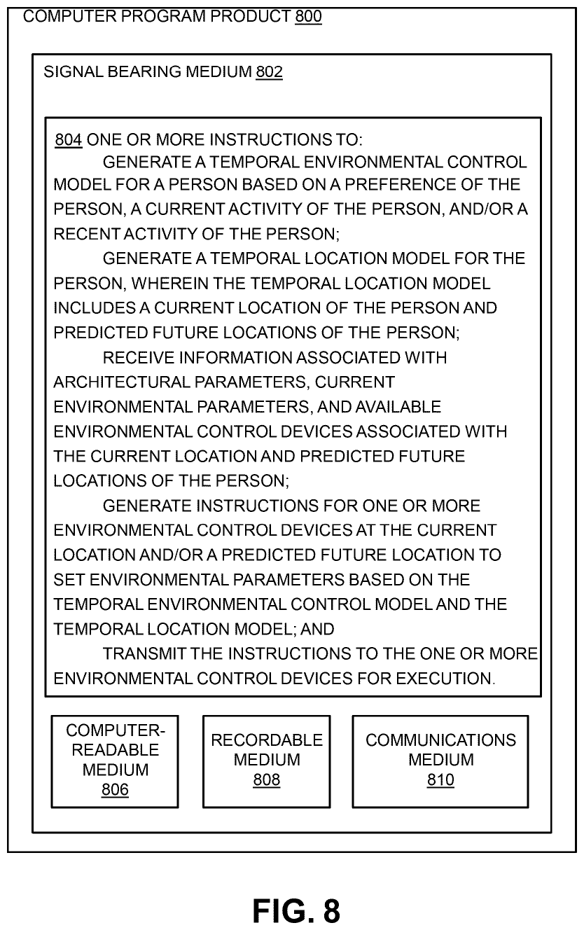

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the control application 622 may perform or control performance of one or more of the tasks shown in FIG. 8 in response to the instructions 804 conveyed to the processor 604 by the signal bearing medium 802 to perform actions associated with the dynamic environment control as described herein. Some of those instructions may include, for example, generate a temporal environmental control model for a person based on a preference of the person, a current activity of the person, and/or a recent activity of the person; generate a temporal location model for the person, where the temporal location model includes a current location of the person and predicted future locations of the person; receive information associated with architectural parameters, current environmental parameters, and/or available environmental control devices associated with the current location or predicted future locations of the person; generate instructions for the environmental control devices at the current location and/or a predicted future location to set environmental parameters based on the temporal environmental control model and the temporal location model; and/or transmit the instructions to the environmental control devices for execution, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, and comparable non-transitory computer-readable storage media. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples, a method for dynamic environment control may include generating a temporal environmental control model for a person based on one or more of a preference of the person, a current activity of the person, or a recent activity of the person; generating a temporal location model for the person, where the temporal location model includes a current location of the person and predicted future locations of the person; receiving information associated with one or more of architectural parameters, current environmental parameters, and available environmental control devices associated with the current location or predicted future locations of the person; generating instructions for one or more environmental control devices at the current location and/or a predicted future location to set environmental parameters based on the temporal environmental control model and the temporal location model; and transmitting the instructions to the one or more environmental control devices for execution.

According to other examples, generating the temporal environmental control model for the person may include determining one or more environmental parameters for the current location based on one or more of the preference of the person, the current activity of the person, or the recent activity of the person, where the one or more environmental parameters are time-based. The method may further include receiving one or more of data from a first environmental sensor internal to the current location, data from a second environmental sensor external to the current location, or data from a body sensor associated with the person and adjusting the one or more environmental parameters for the current location based on the received data. Receiving data from the first environmental sensor internal to the current location or data from the second environmental sensor external to the current location may include receiving sensed data for one or more of a temperature, a humidity, an air flow speed, a lighting level, a lighting composition, a sound level, a smell, or a sound composition.

According to further examples receiving the data from the body sensor may include receiving data associated with one or more of a heart rate, a body temperature, a blood pressure, body movement, or a cognitive or behavioral function associated with the person. Generating the temporal location model for the person may include receiving information for a future location of the person based on one or more of a calendar, a location service, or a mobile device associated with the person; and determining one or more environmental parameters for a future location based on one or more of the received information, the preference of the person, the current activity of the person, or the recent activity of the person. The method may further include determining presence of two or more persons at the location; combining generated temporal environmental control models for the two or more persons; and generating instructions for the one or more environmental control devices at the current location based on the combined temporal environmental control models. Combining the generated temporal environmental control models for the two or more persons may include determining one or more of a personal characteristic or a priority level for each person; and combining the generated temporal environmental control models based on the one or more of the personal characteristic or the priority level for each person.

According to some examples, the method may further include detecting pending arrival of a new person at the location; receiving a new temporal environmental control model for the new person; and combining the generated temporal environmental control model and new temporal environmental control model. Receiving the information associated with the one or more of architectural parameters, current environmental parameters, and available environmental control devices may include receiving the information from one or more of an environmental control device, a desktop computer, a handheld computer, a smart phone, a smartwatch, a vehicle-mount computer, or a remote server. The location may be a room, a house, an office, a school, a health care facility, a hotel, a factory, an automobile, a bus, a recreational vehicle, an airplane, a train, or a ship. The method may also include receiving one or more of the preference of the person, the current activity of the person, the recent activity of the person, the current location of the person, the predicted future locations of the person, the architectural parameters, the current environmental parameters, or the available environmental control devices; and applying a machine learning algorithm to generate the temporal environmental control model and the instructions for the one or more environmental control devices. The one or more environmental control devices may include a heating element, a cooling element, an air flow element, a light source, a shading controller, a tinting controller, a smell source, or a sound source. The method may further include receiving captured image or video of the person at the current location; and applying a machine learning algorithm to interpret a behavior recorded in the captured image or video to adjust the one or more environmental parameters for the current location.

According to other examples, a controller configured to dynamically control environmental conditions may include a communication device configured to communicate with one or more environmental control device, environmental sensors, and computing devices; a memory configured to store instructions; and a processor coupled to the communication device and the memory. The processor, in conjunction with the instructions stored on the memory, may be configured to generate a temporal environmental control model for a person based on one or more of a preference of the person, a current activity of the person, or a recent activity of the person; generate a temporal location model for the person, where the temporal location model includes a current location of the person and predicted future locations of the person; receive information associated with one or more of architectural parameters, current environmental parameters, and available environmental control devices associated with the current location or predicted future locations of the person; generate instructions for the one or more environmental control devices at the current location and/or a predicted future location to set environmental parameters based on the temporal environmental control model and the temporal location model; and transmit the instructions to the one or more environmental control devices for execution.

According to further examples, the processor may also determine one or more environmental parameters for the current location based on one or more of the preference of the person, the current activity of the person, or the recent activity of the person, where the one or more environmental parameters are time-based. The processor may further receive one or more of data from a first environmental sensor internal to the current location, data from a second environmental sensor external to the current location, or data from a body sensor associated with the person; and adjust the one or more environmental parameters for the current location based on the received data. The processor may also receive sensed data for one or more of a temperature, a humidity, an air flow speed, a lighting level, a lighting composition, a sound level, a smell, or a sound composition. The processor may further receive data from the body sensor associated with one or more of a heart rate, a body temperature, a blood pressure, body movement, or a cognitive or behavioral function associated with the person.

According to some examples, to generate the temporal location model for the person, the processor may receive information for a future location of the person based on one or more of a calendar, a location service, or a mobile device associated with the person; and determine one or more environmental parameters for a future location based on one or more of the received information, the preference of the person, the current activity of the person, or the recent activity of the person. The processor may also determine presence of two or more persons at the location; combine generated temporal environmental control models for the two or more persons; and generate instructions for the one or more environmental control devices at the current location based on the combined temporal environmental control models. To combine the generated temporal environmental control models for the two or more persons, the processor may determine one or more of a personal characteristic or a priority level for each person; and combine the generated temporal environmental control models based on the one or more of the personal characteristic or the priority level for each person. The processor may also detect pending arrival of a new person at the location; receive a new temporal environmental control model for the new person; and combine the generated temporal environmental control model and new temporal environmental control model.

According to other examples, the processor may be configured to receive the information associated with the one or more of architectural parameters, current environmental parameters, and available environmental control devices from one or more of an environmental control device, a desktop computer, a handheld computer, a smart phone, a smartwatch, a vehicle-mount computer, or a remote server. The location may be a room, a house, an office, a school, a health care facility, a hotel, a factory, an automobile, a bus, a recreational vehicle, an airplane, a train, or a ship. The processor may further receive one or more of the preference of the person, the current activity of the person, the recent activity of the person, the current location of the person, the predicted future locations of the person, the architectural parameters, the current environmental parameters, or the available environmental control devices; and apply a machine learning algorithm to generate the temporal environmental control model and the instructions for the one or more environmental control devices. The one or more environmental control devices may include a heating element, a cooling element, an air flow element, a light source, a shading controller, a tinting controller, a smell source, or a sound source. The processor may further store at least one of the generated temporal environmental control model and generated temporal location model to a mobile device associated with the person. The processor may also receive captured image or video of the person at the current location; and apply a machine learning algorithm to interpret a behavior recorded in the captured image or video to adjust the one or more environmental parameters for the current location.

According to further examples, an environmental control system (ECS) may include one or more environmental control devices associated with a location; one or more environmental sensors associated with the location; and a controller communicatively coupled to the one or more environmental control devices and environmental sensors. The controller may be configured to generate a temporal environmental control model for a person based on one or more of a preference of the person, a current activity of the person, or a recent activity of the person; generate a temporal location model for the person, where the temporal location model includes a current location of the person and predicted future locations of the person; receive information associated with one or more of architectural parameters, current environmental parameters, and available environmental control devices associated with the current location or predicted future locations of the person; generate instructions for the one or more environmental control devices at the current location and/or a predicted future location to set environmental parameters based on the temporal environmental control model and the temporal location model; and transmit the instructions to the one or more environmental control devices for execution.

According to some examples, the controller may further determine one or more environmental parameters for the current location based on one or more of the preference of the person, the current activity of the person, or the recent activity of the person, where the one or more environmental parameters are time-based. The controller may also receive one or more of data from a first environmental sensor internal to the current location, data from a second environmental sensor external to the current location, or data from a body sensor associated with the person; and adjust the one or more environmental parameters for the current location based on the received data. The controller may further receive sensed data for one or more of a temperature, a humidity, an air flow speed, a lighting level, a lighting composition, a sound level, a smell, or a sound composition. The controller may also receive data from the body sensor associated with one or more of a heart rate, a body temperature, a blood pressure, body movement, or a cognitive or behavioral function associated with the person.

According to other examples, to generate the temporal location model for the person, the controller may receive information for a future location of the person based on one or more of a calendar, a location service, or a mobile device associated with the person; and determine one or more environmental parameters for a future location based on one or more of the received information, the preference of the person, the current activity of the person, or the recent activity of the person. The controller may also determine presence of two or more persons at the location; combine generated temporal environmental control models for the two or more persons; and generate instructions for the one or more environmental control devices at the current location based on the combined temporal environmental control models. To combine the generated temporal environmental control models for the two or more persons, the controller may determine one or more of a personal characteristic or a priority level for each person; and combine the generated temporal environmental control models based on the one or more of the personal characteristic or the priority level for each person. The controller may also detect pending arrival of a new person at the location; receive a new temporal environmental control model for the new person; and combine the generated temporal environmental control model and new temporal environmental control model.

According to further examples, the controller may be configured to receive the information associated with the one or more of architectural parameters, current environmental parameters, and available environmental control devices from one or more of an environmental control device, a desktop computer, a handheld computer, a smart phone, a smartwatch, a vehicle-mount computer, or a remote server. The location may be a room, a house, an office, a school, a health care facility, a hotel, a factory, an automobile, a bus, a recreational vehicle, an airplane, a train, or a ship. The controller may further receive one or more of the preference of the person, the current activity of the person, the recent activity of the person, the current location of the person, the predicted future locations of the person, the architectural parameters, the current environmental parameters, or the available environmental control devices; and apply a machine learning algorithm to generate the temporal environmental control model and the instructions for the one or more environmental control devices. The one or more environmental control devices may include a heating element, a cooling element, an air flow element, a light source, a shading controller, a tinting controller, a smell source, or a sound source. The controller may also store at least one of the generated temporal environmental control model and generated temporal location model to a mobile device associated with the person. The controller may further receive captured image or video of the person at the current location; and apply a machine learning algorithm to interpret a behavior recorded in the captured image or video to adjust the one or more environmental parameters for the current location.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, t some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1-24. (canceled)

25. A method for dynamic environment control, the method comprising:
generating, by a processor, a temporal environmental control model for a person based on one or more of a preference of the person, a current activity of the person, or a recent activity of the person;
generating, by the processor, a temporal location model for the person, wherein the temporal location model includes a current location of the person and predicted future locations of the person;
receiving, by the processor, information associated with one or more of architectural parameters, current environmental parameters, and available environmental control devices associated with the current location or predicted future locations of the person, wherein
the location is a room, a house, an office, a school, a health care facility, a hotel, a factory, an automobile, a bus, a recreational vehicle, an airplane, a train, or a ship;
generating, by the processor, instructions for one or more environmental control devices at the current location and/or a predicted future location to set environmental parameters based on the temporal environmental control model and the temporal location model; and
transmitting, by the processor, the instructions to the one or more environmental control devices for execution.

26. The method of claim 25, wherein generating the temporal environmental control model for the person comprises:
determining one or more environmental parameters for the current location based on one or more of the preference of the person, the current activity of the person, or the recent activity of the person, wherein the one or more environmental parameters are time-based.

27. The method of claim 26, further comprising:
receiving one or more of data from a first environmental sensor internal to the current location, data from a second environmental sensor external to the current location, or data from a body sensor associated with the person wherein,
receiving the data from the body sensor comprises receiving data associated with one or more of a heart rate, a body temperature, a blood pressure, a body movement, or a cognitive or behavioral function associated with the person ; and
adjusting the one or more environmental parameters for the current location based on the received data.

28. The method of claim 27, wherein receiving data from the first environmental sensor internal to the current location or data from the second environmental sensor external to the current location comprises:
receiving sensed data for one or more of a temperature, a humidity, an air flow speed, a lighting level, a lighting composition, a sound level, a smell, or a sound composition.

29. The method of claim 25, wherein generating the temporal location model for the person further comprises:
receiving information for a future location of the person based on one or more of a calendar, a location service, or a mobile device associated with the person; and
determining one or more environmental parameters for the future location based on one or more of the received information, the preference of the person, the current activity of the person, or the recent activity of the person.

30. The method of claim 25, further comprising:
determining presence of two or more persons at the current location or predicted future location;
combining generated temporal environmental control models for the two or more persons using a machine learning algorithm further comprising:
determining one or more of a personal characteristic or a priority level for each person; and
combining the generated temporal environmental control models based on the one or more of the personal characteristic or the priority level for each person; and
generating instructions for the one or more environmental control devices at the current location based on the combined temporal environmental control models.

31. The method of claim 25, further comprising:
detecting pending arrival of a new person at the location;
receiving a new temporal environmental control model for the new person; and
combining the generated temporal environmental control model and new temporal environmental control model.

32. The method of claim 25, further comprising:
receiving one or more of the preference of the person, the current activity of the person, the recent activity of the person, the current location of the person, the predicted future locations of the person, the architectural parameters, the current environmental parameters, or the available environmental control devices; and
applying a machine learning algorithm to generate the temporal environmental control model and the instructions for the one or more environmental control devices.

33. The method of claim 25, wherein the one or more environmental control devices include a heating element, a cooling element, an air flow element, a light source, a shading controller, a tinting controller, a smell source, or a sound source.

34. The method of claim 25, further comprising:
receiving captured image or video of the person at the current location; and
applying a machine learning algorithm to interpret a behavior recorded in the captured image or video to adjust the one or more environmental parameters for the current location.

35. A controller configured to dynamically control environmental conditions, the controller comprising:
a communication device configured to communicate with one or more environmental control device, environmental sensors, and computing devices;
a memory configured to store instructions; and
a processor coupled to the communication device and the memory, wherein the processor in conjunction with the instructions stored in the memory is configured to:
generate a temporal environmental control model for a person based on one or more of a preference of the person, a current activity of the person, or a recent activity of the person;
generate a temporal location model for the person, wherein the temporal location model includes a current location of the person and predicted future locations of the person;
receive information associated with one or more of architectural parameters, current environmental parameters, and available environmental control devices associated with the current location or predicted future locations of the person;
generate instructions for the one or more environmental control devices at the current location and/or a predicted future location to set environmental parameters based on the temporal environmental control model and the temporal location model; and
transmit the instructions to the one or more environmental control devices for execution.

36. The controller of claim 35, wherein the processor is further configured to:
determine one or more environmental parameters for the current location based on one or more of the preference of the person, the current activity of the person, or the recent activity of the person, wherein the one or more environmental parameters are time-based.

37. The controller of claim 35, wherein the processor is further configured to:
receive one or more of data from a first environmental sensor internal to the current location, data from a second environmental sensor external to the current location, or data from a body sensor associated with the person; and
adjust the one or more environmental parameters for the current location based on the received data.

38. The controller of claim 37, wherein the processor is further configured to:
receive sensed data for one or more of a temperature, a humidity, an air flow speed, a lighting level, a lighting composition, a sound level, a smell, or a sound composition.

39. The controller of claim 37, wherein the processor is further configured to:
receive data from the body sensor associated with one or more of a heart rate, a body temperature, a blood pressure, body movement, or a cognitive or behavioral function associated with the person.

40. The controller of claim 36, wherein, to generate the temporal location model for the person, the processor is configured:
receive information for a future location of the person based on one or more of a calendar, a location service, or a mobile device associated with the person; and
determine one or more environmental parameters for the future location based on one or more of the received information, the preference of the person, the current activity of the person, or the recent activity of the person.

41. An environmental control system (ECS) comprising:
one or more environmental control devices associated with a location;
one or more environmental sensors associated with the location; and
a controller communicatively coupled to the one or more environmental control devices and environmental sensors, the controller configured to:
generate a temporal environmental control model for a person based on one or more of a preference of the person, a current activity of the person, or a recent activity of the person;
generate a temporal location model for the person, wherein the temporal location model includes a current location of the person and predicted future locations of the person;
receive information associated with one or more of architectural parameters, current environmental parameters, and available environmental control devices associated with the current location or predicted future locations of the person;
generate instructions for the one or more environmental control devices at the current location and/or a predicted future location to set environmental parameters based on the temporal environmental control model and the temporal location model; and
transmit the instructions to the one or more environmental control devices for execution.

42. The ECS of claim 41, wherein the controller is further configured to:
determine one or more environmental parameters for the current location based on one or more of the preference of the person, the current activity of the person, or the recent activity of the person, wherein the one or more environmental parameters are time-based.

43. The ECS of claim 42, wherein the controller is further configured to:
receive one or more of data from a first environmental sensor internal to the current location, data from a second environmental sensor external to the current location, or data from a body sensor associated with the person; and
adjust the one or more environmental parameters for the current location based on the received data.

44. The ECS of claim 43, wherein the controller is further configured to:
receive sensed data for one or more of a temperature, a humidity, an air flow speed, a lighting level, a lighting composition, a sound level, a smell, or a sound composition.
